(19) United States
(12) Patent Application Publication
(10) Pub. No.: US 2018/0090243 A1
(43) Pub. Date: Mar. 29, 2018

(54) Lossy Drain Wire on a High Speed Cable

(71) Applicant: DELL PRODUCTS, LP, Round Rock, TX (US)

(72) Inventors: Sandor Farkas, Round Rock, TX (US); Stuart Allen Berke, Austin, TX (US); Bhyrav M. Mutnury, Round Rock, TX (US)

(21) Appl. No.: 15/274,567

(22) Filed: Sep. 23, 2016

(51) Int. Cl. H01B 11/18; H01B 13/016; H01B 11/00; H01B 13/26

(52) U.S. Cl. CPC H01B 11/1895; H01B 13/016; H01B 13/2626; H01B 11/1891; H01B 11/002

(57) ABSTRACT

A dual axial cable includes first and second signal conductors, a shield, and a drain wire. The first and second signal conductors transmit a differential signal. The shield is spirally wrapped around the first and second conductors, and causes a resonant characteristic of the dual axial cable. The drain wire provides a return path for the differential signal in the dual axial cable. The drain wire is roughened to a specific amount of roughness, which reduces signal loss at resonant frequencies of the resonant characteristic caused by the shield.

### FIELD OF THE DISCLOSURE

This disclosure generally relates to information handling systems, and more particularly relates to a lossy drain wire on a high speed cable.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A dual axial cable includes first and second signal conductors, a shield, and a drain wire. The first and second signal conductors transmit a differential signal. The shield is spirally wrapped around the first and second conductors, and causes a resonant characteristic of the dual axial cable. The drain wire provides a return path for the differential signal in the dual axial cable. The drain wire is roughened to a specific amount of roughness, which reduces signal loss at resonant frequencies of the resonant characteristic caused by the shield.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is schematic cross-sectional view of a dual axial cable according to an embodiment of the present disclosure;

FIG. 2 is schematic top view of the dual axial cable according to an embodiment of the present disclosure;

FIG. 3 illustrates waveforms associated with the dual axial cable of FIG. 1 according to an embodiment of the present disclosure;

FIG. 4 is schematic cross-sectional view of a dual axial cable according to an embodiment of the present disclosure;

FIG. 5 illustrates waveforms associated with the dual axial cable of FIG. 4 according to an embodiment of the present disclosure; and

FIG. 6 illustrates a flow chart of a method for creating a dual axial cable with reduced signal loss at resonant frequencies according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

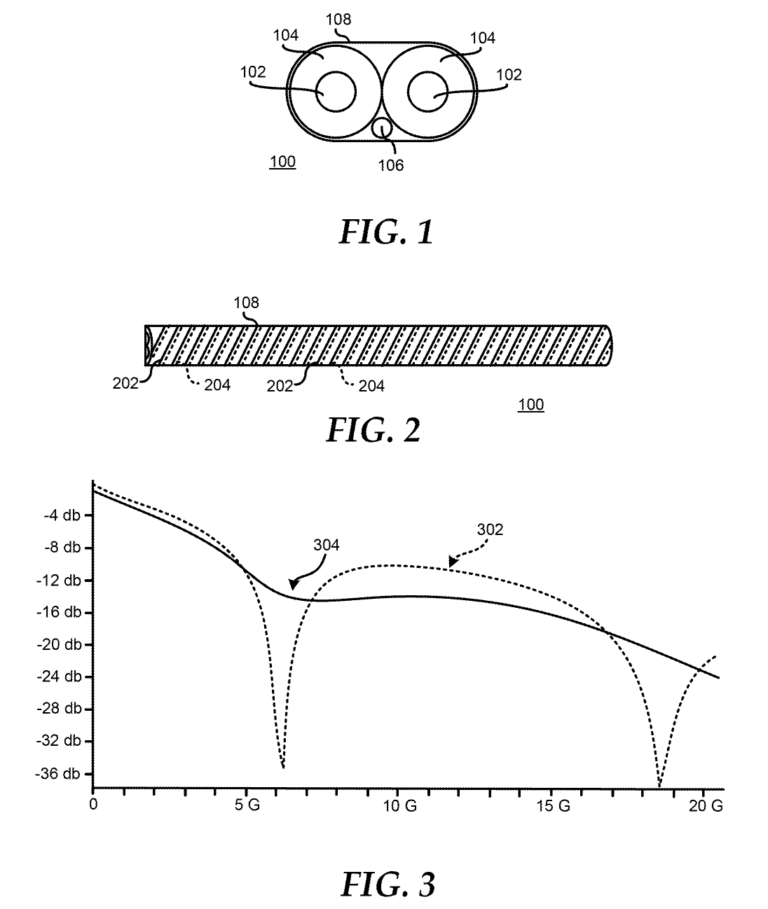

FIG. 1 illustrates an embodiment of a dual axial cable 100 of an information handling system. For the purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch router or other network communication device, or any other suitable device and may vary in size, shape, performance, functionality, and price. Further, an information handling system can include processing resources for executing machine-executable code, such as a central processing unit (CPU), a programmable logic array (PLA), an embedded device such as a System-on-a-Chip (SoC), or other control logic hardware. An information handling system can also include one or more computer-readable medium for storing machine-executable code, such as software or data. Additional components of an information handling system can include one or more storage devices that can store machine-executable code, one or more communications ports for communicating with external devices, and various input and output (I/O) devices, such as a keyboard, a mouse, and a video display. An information handling system can also include one or more buses operable to transmit information between the various hardware components.

The dual axial cable 100 includes conductors 102, insulators 104, a drain wire 106, and a shield 108. The conductors 102 combine to provide the dual axial cable 100 with the ability to transmit differential signals. Each of the conductors 102 are surrounded by an insulator 104. The dual axial conductors 102 can transmit signals for different transmission protocols, such as serial attached small computer system interface (SCSI) (SAS), InfiniBand, serial AT attachment (SATA), peripheral component interconnect express (PCIe), double speed fibre channel, synchronous optical networking (SONET)/synchronous digital hierarchy (SDH) (SONET/SDH), high speed copper, 10 GbE, or the like. In an embodiment, the drain wire 106 is grounded. The conductors 102 are shielded with the shield 108 that is spirally wrapped around the cable 100 as shown in FIG. 2.

As the speed of high speed cables increases, an overlap of a shield wrapped around the dual axial cable can generate a resonance characteristic that can limit performance of the high speed cable.

FIG. 2 illustrates the dual axial cable 100 including the shield 108 according to an embodiment of the present disclosure. The shield 108 includes a thin sheet of aluminum metal laminated upon an insulating substrate, such as polyethylene plastic. The shield 108 can be tightly wrapped around the conductors 102, insulators 104, and the drain wire 106. The wrapping of the shield 108 can keep the conductors 102 together to maintain characteristic impedance for the cable 100, to get good return loss performance, and to provide a low resistive contact between the drain wire 110 and the shield 108. Each strip of the shield 108 wrapped around the cable 100 can overlap the previous strip of the shield 108. For example, the solid lines 202 illustrate a top layer of the shield 108, and the dashed lines 204 illustrate a bottom layer of the shield 108. However, the shield 108 being spirally wrapped around the conductors 102 can cause a resonance characteristic to occur in the cable 100. For example, the overlap of the shield 108, shown by solid lines 202 and dashed lines 204, can cause a inductive capacitive (LC) tank circuit, which can be a bandstop filter, ‘suckout,’ or the resonance characteristic that can limit the performance of the conductor 102. In an embodiment, the limit of performance can be defined as high loss in the cable 100 at resonant frequencies as shown by waveform 302 of FIG. 3.

FIG. 3 illustrates waveforms 302 and 304 associated with the dual axial cable 100 of FIG. 1 according to an embodiment of the present disclosure. Waveform 302 represents signal loss for differential signal frequencies of the cable 100 with the shield 108 spirally overlapping and a smooth drain wire 106. For example, waveform 302 shows high signal loss at resonant frequencies of around 6 GHz and 18.5 GHz. In an embodiment, the high signal loss can be around −36 db as represented by waveform 302.

Referring back to FIG. 1, the drain wire 106 can provide a return current or image current as a return path of the cable 100. The drain wire 106 be roughened to introduce additional loss into the return path of the cable 100, and to dampen the resonance of the overlapping of shield 108. In an embodiment, the roughening of the drain wire 106 can vary to control an impact of the loss introduce in the cable, and this impact can be independent of a frequency of operation of the cable 100. In an embodiment, the roughening of the drain wire 106 can vary in roughness from 25 μm to 250 μm. As the roughness of the drain wire 106 increases, the additional loss in cable 100 is increased while the losses at the resonance frequencies are dampened. In an embodiment, the roughening of the drain wire 106 can reduce losses at resonant frequencies created by the overlap of the shield 108 as shown by waveform 304 of FIG. 3.

Referring back to FIG. 3, waveform 304 represents signal loss for differential signal frequencies of the cable 100 with the shield 108 spirally overlapping and the drain wire 106 roughened. For example, waveform 304 shows that the roughened drain wire 106 makes the cable 100 lossier at frequencies ranges outside of resonant frequencies, but makes the cable less lossy, as compared to a smooth drain wire 106 as illustrated by waveform 302, at resonant frequencies of around 6 GHz and 18.5 GHz. In an embodiment, reduced signal loss can be at the resonant frequencies can be around −14 db at 6 GHz and −22 db at 18.5 GHz, as represented by waveform 302. Thus, the roughened drain wire 106 can save 20 db of loss at the resonant frequencies of the spirally wrapped shield 108.

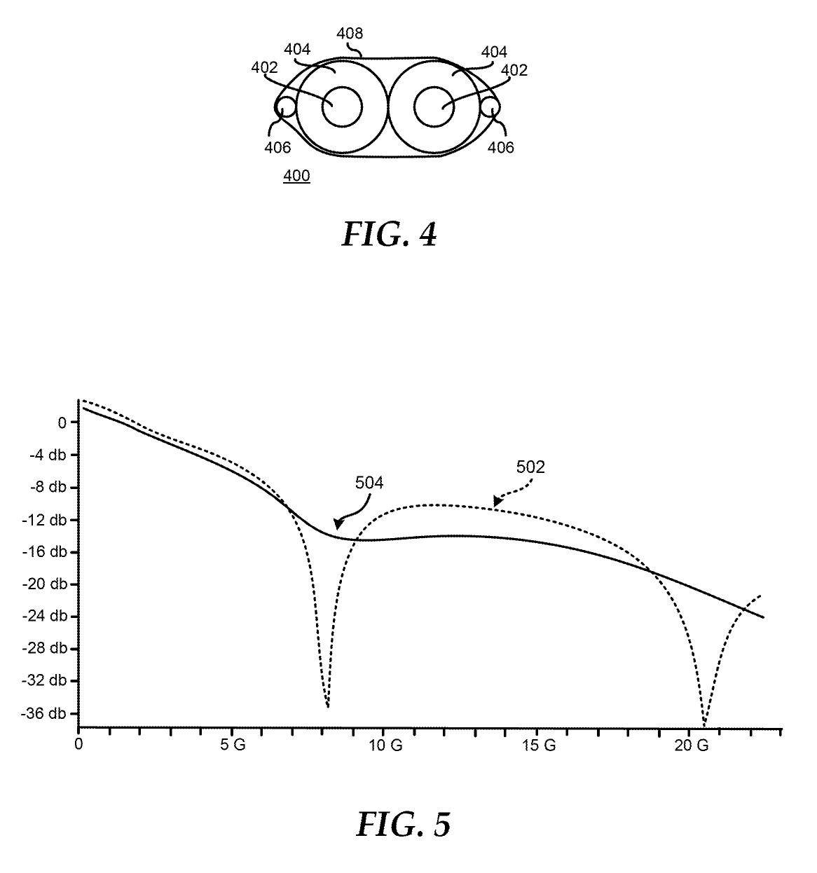

FIG. 4 illustrates a schematic cross-sectional view of a dual axial cable 400 according to an embodiment of the present disclosure. The dual axial cable 400 includes conductors 402, insulators 404, a drain wire 406, and a shield 408. The conductors 402 combine to provide the dual axial cable 400 with the ability to transmit differential signals. Each of the conductors 402 are surrounded by an insulator 404. The conductors 402 are shielded with the shield 408 that is spirally wrapped around the cable 400 in a similarly fashion as cable 100 described above with respect FIG. 2.

The shield 408 is substantially similar to shield 108 described above with respect to cable 100 in FIG. 1. Therefore, shield 408 can be spirally overlapped, such that each strip of the shield 408 is wrapped around the cable 400 can overlap the previous strip of the shield 408. However, the shield 408 being spirally wrapped around the conductors 402 can cause a resonance characteristic to occur in the cable 400. The cable 400 includes two drain wires 406, which can cause the resonant frequencies to be at different frequencies, as compared to the cable 100 that includes a single drain wire 106, as shown in FIG. 5 below.

The drain wires 406 can provide a return current or image current as a return path of the cable 400. The drain wires 406 be roughened to introduce additional loss into the return path of the cable 400, and to dampen the resonance of the overlapping of shield 408. In an embodiment, the roughening of the drain wires 406 can vary to control an impact of the loss introduce in the cable, and this impact can be independent of a frequency of operation of the cable 400. In an embodiment, the roughening of the drain wires 406 can vary in roughness from 25 μm to 250 μm. As the roughness of the drain wires 406 increases, the additional loss in cable 400 is increased while the losses at the resonance frequencies are dampened. In an embodiment, the roughening of the drain wires 406 can reduce losses at resonant frequencies created by the overlap of the shield 408 as shown by waveform 504 of FIG. 5 below.

FIG. 5 illustrates waveforms 502 and 504 associated with the dual axial cable 400 of FIG. 4 according to an embodiment of the present disclosure. Waveform 502 represents signal loss for differential signal frequencies of the cable 400 with the shield 508 spirally overlapping and smooth drain wires 406. For example, waveform 502 shows high signal loss at resonant frequencies of around 6 GHz and 18.5 GHz. In an embodiment, the high signal loss at the resonant frequencies of the shield 408 can be around −36 db as represented by waveform 502.

Waveform 504 represents signal loss for differential signal frequencies of the cable 400 with the shield 408 spirally overlapping and the drain wires 406 roughened. For example, waveform 504 shows that the roughened drain wires 406 makes the cable 400 lossier at frequencies ranges outside of resonant frequencies, but makes the cable less lossy, as compared to smooth drain wires 406 as illustrated by waveform 502, at resonant frequencies of around 8 GHz and 20.5 GHz. In an embodiment, reduced signal loss can be at the resonant frequencies can be around −14 db at 8 GHz and −22 db at 20.5 GHz, as represented by waveform 502. Thus, the roughened drain wires 406 can save 20 db of loss at the resonant frequencies of the spirally wrapped shield 408.

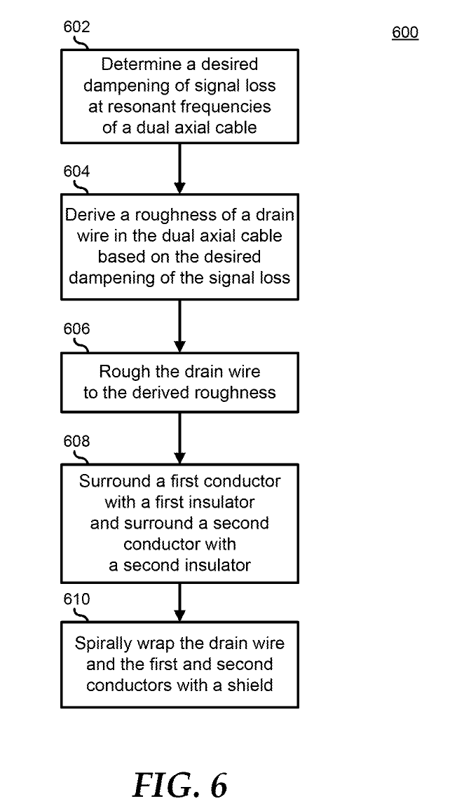

FIG. 6 illustrates a method 600 for creating a dual axial cable with reduced signal loss at resonant frequencies according to an embodiment of the present disclosure. At block 602, a desired dampening of signal loss at resonant frequencies of a dual axial cable is determined. In an embodiment, the dampening of signal loss at resonant frequencies can be independent from the frequencies that the dual axial cable is going to be operated. A roughness of a drain wire in the dual axial cable is derived based on the desired dampening of the signal loss at resonant frequencies at block 604. In an embodiment, the roughening of the drain wire can vary in roughness from 25 μm to 250 μm.

At block 606, the drain wire is roughened to the derived roughness. A first conductor is surrounded by a first insulator and a second conductor is surrounded by a second insulator at block 608. At block 610, the drain wire and the first and second conductors are spirally wrapped with a shield. In an embodiment, the spiral wrapping of the shield causes overlap in the shield, which in turn causes high signal loss at resonant frequencies unless dampened by a roughened drain wire.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

1. A dual axial cable comprising:
first and second signal conductors to transmit a differential signal;
a shield spirally wrapped around the first and second conductors, wherein the shield causes a resonant characteristic of the dual axial cable; and
a drain wire to provide a return path for the differential signal, the drain wire being roughened to a specific amount of roughness, wherein the specific amount of roughness causes a reduction of a signal loss at resonant frequencies of the resonant characteristic caused by the shield.

2. The dual axial cable of claim 1, further comprising:
a first insulator surrounding the first conductor and in physical communication with the shield.

3. The dual axial cable of claim 2, further comprising:
a second insulator surrounding the second conductor and in physical communication with the shield.

4. The dual axial cable of claim 1, wherein the specific amount of roughness is within a range of roughness from 25 μm to 250 μm.

5. The dual axial cable of claim 1, wherein the spiral wrapping of the shield causes overlaps in the shield.

6. The dual axial cable of claim 5, wherein the resonant frequencies are caused by the overlap in the shield.

7. The dual axial cable of claim 1, wherein the reduction of the signal loss at the resonant frequencies is independent from frequencies that the dual axial cable is operated.

8. A dual axial cable comprising:
first and second signal conductors to transmit a differential signal;
a shield spirally wrapped around the first and second conductors, wherein the shield causes a resonant characteristic of the dual axial cable;
a first drain wire to provide a first return path for the differential signal; and
a second drain wire to provide a second return path for the differential signal, the first and second drain wires being roughened to a specific amount of roughness, wherein the specific amount of roughness causes a reduction of a signal loss at resonant frequencies of the resonant characteristic caused by the shield.

9. The dual axial cable of claim 8, further comprising:
a first insulator surrounding the first conductor and in physical communication with the shield.

10. The dual axial cable of claim 9, further comprising:
a second insulator surrounding the second conductor and in physical communication with the shield.

11. The dual axial cable of claim 8, wherein the specific amount of roughness is within a range of roughness from 25 μm to 250 μm.

12. The dual axial cable of claim 8, wherein the spiral wrapping of the shield causes overlaps in the shield.

13. The dual axial cable of claim 12, wherein the resonant frequencies are caused by the overlap in the shield.

14. The dual axial cable of claim 8, wherein the reduction of the signal loss at the resonant frequencies is independent from frequencies that the dual axial cable is operated.

15. A method comprising:
determining a desired dampening of signal loss at resonant frequencies of a dual axial cable;
roughening a drain wire in the dual axial cable to a roughness derived based on the desired dampening of the signal loss at the resonant frequencies; and
spirally wrapping the drain wire and first and second conductors with a shield, wherein spirally wrapping of the shield high cause signal loss at resonant frequencies unless dampened by a roughened drain wire.

16. The method of claim 15, further comprising:
surrounding the first conductor by a first insulator prior to spirally wrapping the drain wire and the first and second conductors with the shield; and
surrounding the second conductor by a second insulator prior to spirally wrapping the drain wire and the first and second conductors with the shield.

17. The method of claim 15, wherein the dampening of the signal loss at the resonant frequencies is independent from frequencies that the dual axial cable is operated.

18. The method of claim 15, wherein the derived roughness is within a range of roughness from 25 μm to 250 μm.

19. The method of claim 15, wherein the spiral wrapping of the shield causes overlaps in the shield.

20. The method of claim 19, wherein the resonant frequencies are caused by the overlap in the shield.
